(19) United States
(12) Patent Application Publication
(10) Pub. No.: US 2015/0321644 A1
(43) Pub. Date: Nov. 12, 2015

(54) Detection of Raindrops on a Pane by Means of a Camera and Illumination

(71) Applicant: Conti Temic microelectronic GmbH, Nuernberg (DE)

(72) Inventors: Christopher KOSUBEK, Ulm (DE); Dieter KROEKEL, Eriskirch (DE); Wolfgang FEY, Bodolz (DE); Martin RANDLER, Immenstaad (DE)

(21) Appl. No.: 14/394,358

(22) PCT Filed: Aug. 2, 2013
(86) PCT No.: PCT/DE2013/200094

§ 371 Date: Oct. 14, 2014

(30) Foreign Application Priority Data
Aug. 6, 2012 (DE) 10 2012 107 198.5
Sep. 7, 2012 (DE) 10 2012 108 316.9
Jan. 11, 2013 (DE) 10 2013 100 292.7

(51) Int. Cl. B60S 1/08; H04N 5/225; H04N 9/04; G06K 9/00

(52) U.S. Cl. CPC B60S 1/0844; G06K 9/00791; H04N 5/2256; H04N 9/045; H04N 2209/045

(57) ABSTRACT

The invention relates to a device and a method for detecting rain (4). The device for detecting rain comprises a camera with an image sensor (5) and colour filters for pixels of the image sensor in a number of primary filter colours (R; G; B) and an illumination source (3) for producing monochromatic light (h) of a first primary filter colour. The monochromatic light is provided in a visible wavelength range which is transmitted by the first primary filter colour and blocked by the other primary filter colours.

The camera and the illumination source (3) are designed and arranged in such a manner that the camera can detect a signal from the monochromatic light (r1, r2′) with which the illumination source illuminates a pane (2).

The invention relates to a device and a method for the detection of raindrops on a pane by means of an illumination source and a camera.

U.S. Pat. No. 7,259,367 B2 suggests a rain sensing method using a camera which provides that a wide area of the pass-through window of the aperture angle of the camera with the pane is illuminated. The camera is focused almost to infinity and can thereby be used simultaneously for driver assistance applications. Due to the focus on the far range, raindrops can be perceived only as disturbances in the image which are detected by elaborate measurements of differential values of the images recorded using light which is pulsed or modulated in synchronization with the pixel rate frequency.

In WO 2012/092911 A1, a device and a method for detecting rain are described. A camera is disposed behind a pane, in particular in the interior of a vehicle behind a windscreen, and focused onto a remote region that lies in front of the pane. A lighting source for generating at least one light beam that is directed at the pane directs the at least one light beam onto the pane such that at least one beam that is reflected from the outer side of the pane impinges on the camera as an external light reflection or an external reflection. The light quantity of the at least one beam or light reflection that impinges on the camera can be measured by the camera. In addition, the lighting source can direct the at least one light beam onto the pane such that the beams reflected from the inner and outer side of the pane hit the camera as at least two spatially separated beams. The light quantities of the at least two beams (external and internal reflection) hitting the camera can now be measured by the camera. The beam reflected (directly) at the inner side of the pane and hitting the camera serves in this context as a reference signal, since the light quantity of said beam remains constant regardless of whether or not raindrops are present on the outer side of the pane.

In order to minimise background influences and improve the signal-to-noise ratio, a temporal modulation of the lighting adjusted to the pulse of the refresh rate is proposed.

In the case of a modulation of 100%, this means that one image is fully illuminated and the next image is not illuminated. If the scene does not change between the two shots, a complete reduction of the background influences can be achieved via subtraction of the two images so that only the light reflected by the windscreen remains for the evaluation.

However, the idealised assumption of an unchanged background between two shots is of only limited application in practice. When driving, in particular around curves, the background changes to a greater or lesser extent, meaning that the background influence can only be inadequately compensated for. It superposes with the actual rain signal and may thus lead to misevaluations of the rain signal. It is possible to add sufficient tolerance to the threshold for detecting a wetted windscreen in order to avoid false activation of the wiper, but this inevitably leads to a correspondingly more insensitive behaviour.

DE 602 04 567 T2 shows an interleaved mosaic imaging rain sensor that comprises an illumination device for illuminating a glass with light rays at a first wavelength and is designed to simultaneously capture an illuminated image at a first wavelength and an ambient image of light rays at a second wavelength and to compare the two images to produce a moisture signal. Instead of RGB colour filters, the invention utilises a mosaic or stripe array of infrared band pass filters.

It is the object of the present invention to overcome the above-mentioned problems inherent in the devices and/or methods known from the prior art.

The starting point for the solution is the utilisation of image sensors with colour filters. Widely used is the Bayer pattern which utilises as colour filters the three primary colours green, red and blue in the known arrangement red-green-green-blue. An illumination in the visible wavelength range provides the advantage that commonly used driver assistance cameras with colour resolution can fully cover this spectral range while, on the other hand, infrared light usually does not pass the infrared cut-off filters commonly used for optimised colour resolution and thus cannot be detected by said driver assistance cameras.

A device for detecting rain according to the present invention comprises a camera with an image sensor and colour filters for pixels of the image sensor in a number of primary filter colours and an illumination source for producing monochromatic light of a first primary filter colour. The monochromatic light is provided in a visible wavelength range which is transmitted by the first primary filter colour and blocked by the other primary filter colours. The primary filter colours are preferably provided in different visible wavelength ranges. The light of the illumination source is provided in a wavelength range that is adapted to a first primary filter colour. This facilitates the use of traditional cameras with colour resolution. The camera preferably comprises an infrared cut-off filter which ensures that no infrared light can be captured by the image sensor.

The camera and the illumination source are designed and arranged in such a manner that the camera can detect a signal from the monochromatic light with which the illumination source illuminates a pane. In particular, the signal detected by the camera here correlates to monochromatic light emitted by the illumination source that has been reflected and/or scattered by the inner and/or outer side of the pane and/or the raindrop.

The camera is preferably arranged behind the pane, in particular in the interior of a vehicle, e.g. behind a windscreen.

Preferably, the camera comprises an image sensor, e.g. a CCD or CMOS sensor, and an objective for focussing electromagnetic radiation onto the image sensor.

It is advantageous to focus the camera to infinity or on a far range located in front of the pane.

The illumination source for producing monochromatic light directs the at least one light beam onto the pane, preferably in such a manner that at least one beam reflected by the outer side of the pane (or a partial beam of the beam directed onto the pane) hits the camera, said beam hitting the camera preferably without being superposed with partial beams reflected at the inner side of the pane.

The illumination source can be designed as one or several light-emitting diodes (LED) or as a light-band.

The reflected illumination of the at least one monochromatic beam hitting the camera can be detected by the camera.

In a preferred embodiment of the invention, the lighting source directs the at least one monochromatic light beam onto the pane in such a manner that the beams reflected from the inner and outer side of the pane hit the camera as at least two spatially separated beams. It is not necessary for the beams, in particular for the beam reflected at the inner side, to be fully imaged on the image sensor of the camera. The monochromatic illumination reflections of the at least two beams hitting the camera can be detected by the camera in spatial separation.

The beam reflected (directly) at the inner side of the pane and hitting the camera serves in this context preferably as a possible reference signal, since the light quantity of said beam remains constant regardless of whether or not raindrops are present on the outer side of the pane.

A basic idea underlying the invention is to provide illumination with monochromatic, e.g. with blue, light. As a result of this, a rain-dependent or wetting-dependent signal can only be detected on the corresponding (blue) pixels, since the red and green pixels are not transparent to blue light.

This provides the advantage that a simultaneous recording of the background is carried out, which can be determined in a pixel-precise manner from the neighbouring non-blue pixels.

The invention further relates to a method for detecting rain with a camera, wherein the camera comprises an image sensor and colour filters for pixels of the image sensor in a number of primary filter colours.

Monochromatic light of a first filter colour is generated by an illumination source. A pane is illuminated with the monochromatic light in such a manner that the camera can detect a signal from said monochromatic light.

In an advantageous embodiment of the invention, the brightness value of a first image sensor pixel of the first primary filter colour is determined. In addition, the brightness values of the pixels which surround the first image sensor pixel and have a filter pixel colour differing from the first filter pixel colour are determined. By using the brightness values determined for the pixels which surround the first image sensor pixel and have a filter pixel colour differing from the first filter pixel colour, a background brightness of the first image sensor pixel is established.

This allows taking the background signal into account in a pixel-precise manner. That in turn achieves a considerably improved spatial resolution of the wetting signal.

The brightness of the eight red and green pixels surrounding a blue pixel is preferably measured simultaneously. Their brightness is influenced solely by the background. The brightness values of these pixels are now used to estimate the background signal of the blue pixel, e.g. by averaging. Alternatively it is conceivable to weight the red and green portions differently, thereby taking a specific spectral distribution of the background into account.

This background value can preferably be weighted again in a suitable way, since it is only the blue portion of the background that should be subtracted from the signal of the blue pixels.

The proportional factors for the suitable weightings can be determined e.g. empirically. It turns out that the blue background portion can be estimated fairly accurately in many scenarios with somewhat uniformly distributed spectral distributions.

However, if one colour, e.g. red, is predominant in the background, the blue portion subtracted for the blue pixel would also be too high. This type of shift in the spectral distribution, however, can already be determined via the red-to-green ratio and taken into account when weighting the factors.

Additionally, these weighting factors can be verified or accordingly modified via a further measurement in the unilluminated state. Since this measurement is performed via time-shifted images, it should be made sure that there is very little or little change in the background (e.g. when the vehicle is stationary). As an alternative, image-processing techniques could be used to follow the relevant partial image over a period of time (“tracking”) in order to calculate the factors based on a background that is as unadulterated as possible.

Instead of using blue light for the illumination, it is also advantageously conceivable to use red light with the same pixel colour pattern. The background would then be calculated analogously via the blue and green pixels.

In an alternative utilisation of green light for illumination purposes, the background would have to be calculated based on the two blue and two red pixels immediately adjacent to the green pixel.

In a preferred embodiment of the invention, different colour patterns would be used instead of the Bayer filter. In fact, even a colour filter with just two primary colours (e.g. red and blue) is sufficient for a method of the present invention.

For taking the background into account in a timely and accurate manner, it is particularly preferable to use a colour pattern in which one colour provides a high transmission rate for the illumination used and which simultaneously blocks the illumination on the other colour pixels efficiently.

According to a preferred further form of the invention, the current background-eliminated measurement signal is normalised to a background-eliminated measurement signal for a dry pane. The normalisation can be performed for each (e.g. blue) pixel in particular by dividing the current background-eliminated intensity of the pixel by the background-eliminated intensity of the same pixel for a dry pane. The background-eliminated intensity for a dry pane can be determined and stored in the context of the initial calibration. It can also be automatically recalibrated from time to time whenever a dry pane is detected.

Following the same method, it is also possible at any time to acquire an unaffected reference signal (corresponding to a dry pane) from the reflected image at the inner side of the pane (WO 2012/092911 A1). It differs from the outer reflected image—as long as the outer reflected image is unaffected as well—only by its higher intensity. This factor remains constant and can therefore be used in calculating ratios once it has been initially determined.

The invention will be explained in the following in more detail using figures and exemplary embodiments.

The figures show:

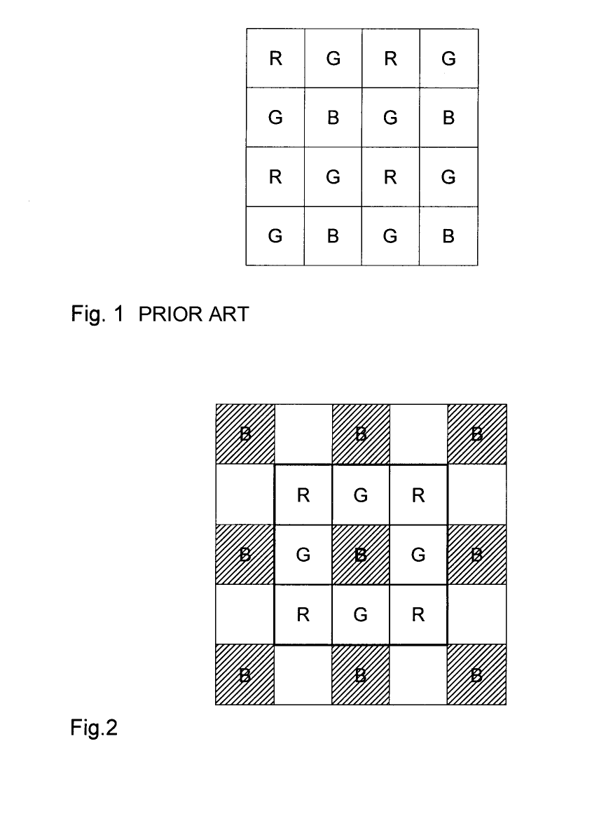

FIG. 1 a colour filter arrangement according to Bayer;

FIG. 2 the utilisation of the red and green pixels surrounding a blue pixel to calculate the background signal of the blue pixel;

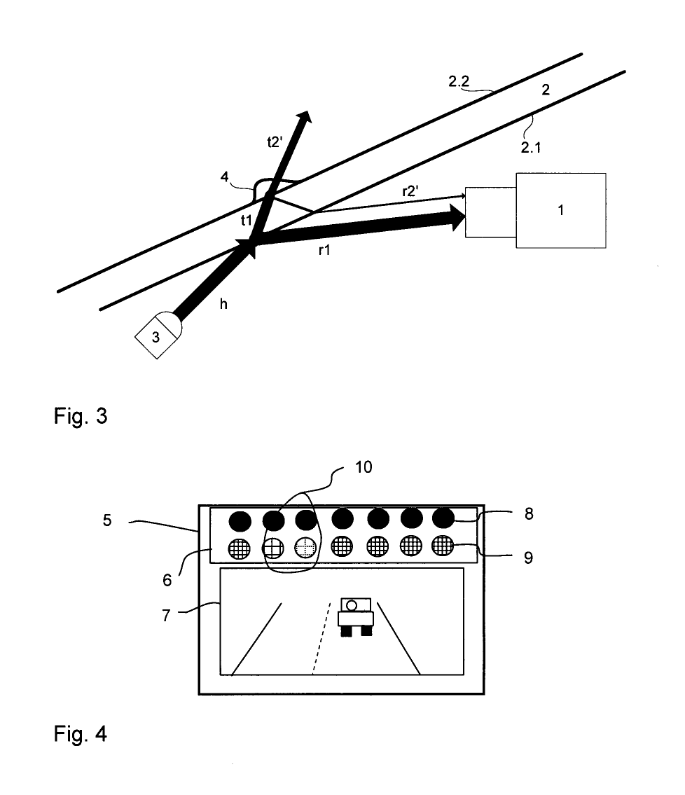

FIG. 3 a schematic representation of the basic principle of a possible arrangement of illumination source and camera, including beam paths if rain is present on the pane;

FIG. 4 signals detected by an image sensor of a camera which indicate presence of rain;

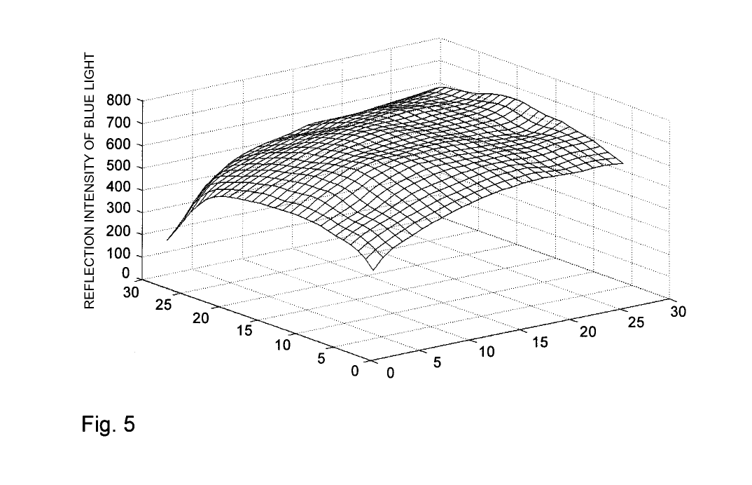

FIG. 5 a spatial distribution of the illuminated area after subtracting the background signal for a dry pane;

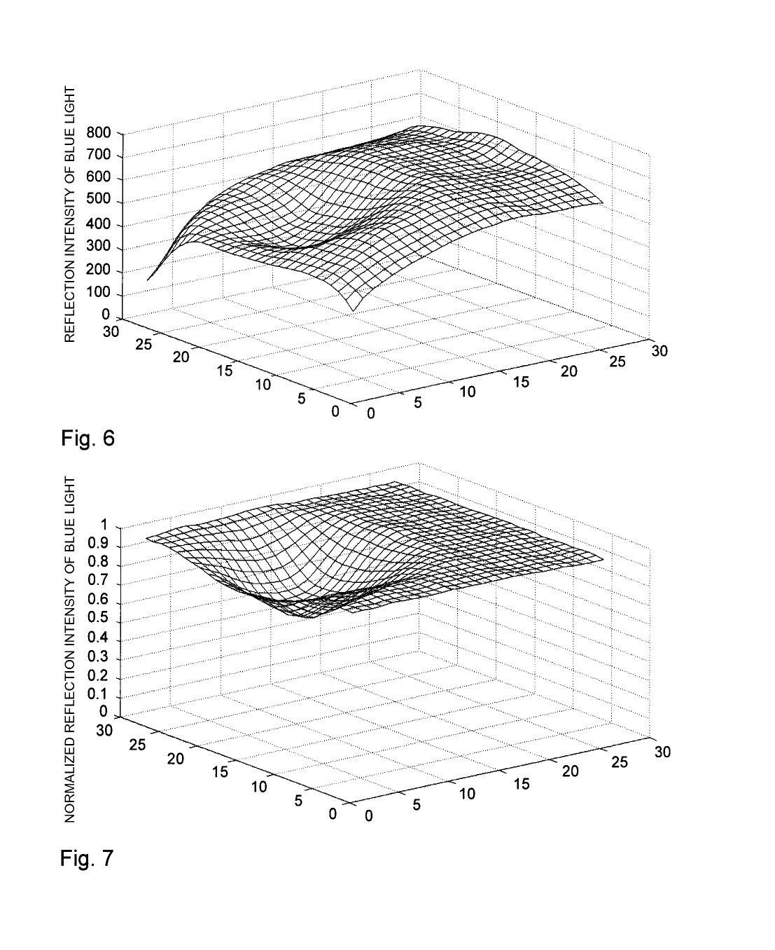

FIG. 6 a spatial signal distribution after subtracting the background signal if the pane has been wetted by a small raindrop less than 1 mm in diameter and

FIG. 7 the signal distribution of FIG. 6 normalised to the unaffected signal distribution of FIG. 5.

The Bayer pattern shown in FIG. 1 and known from U.S. Pat. No. 3,971,065, which uses the three primary colours green (G), red (R), blue (B) as a colour filter with the arrangement red-green-green-blue (RGGB) as filter pixel matrix, is widely used as a colour filter for image sensors.

A first embodiment of the invention will be explained in detail using FIG. 2, which provides a partial view of a Bayer pattern.

Blue light is used for illumination in order to facilitate the simultaneous creation of an image of the background. As a result of this, a rain-dependent or wetting-dependent signal can only be detected on the blue pixels (B, hatched), since the red (R) and green (G) pixels are not transparent to blue light.

At the same time, the brightness of the eight red (R) and green (G) pixels surrounding a blue pixel is measured. In FIG. 2 this means measuring the brightness values of the four red (R) and four green (G) pixels (inside the thicker grid lines) surrounding the central blue pixel (bold B). Their brightness is influenced solely by the background. The brightness values of these pixels are now used to estimate the background signal of the blue pixel (B), e.g. by averaging. Alternatively it is conceivable to weight the red and green portions differently, thereby taking a specific spectral distribution of the background into account.

This background value is weighted again in a suitable way, since only the blue portion of the background is to be subtracted from the signal of the blue pixels (B).

These factors can be determined e.g. empirically. It turns out that the blue background portion can be estimated fairly accurately in many scenarios with somewhat uniformly distributed spectral distributions.

However, if one colour, e.g. red, is predominant in the background, the blue portion subtracted for the blue pixel (B) would also be too high. This type of shift in the spectral distribution, however, can already be determined via the red-to-green ratio and taken into account when weighting the factors.

Additionally, these weighting factors can be verified or accordingly modified via a further measurement in the unilluminated state. Since this measurement is performed via time-shifted images, it should be made sure that there is very little or little change in the background (e.g. when the vehicle is stationary). As an alternative, image-processing techniques could be used to follow the relevant partial image over a period of time (“tracking”) in order to calculate the factors based on a background that is as unadulterated as possible.

FIG. 3 shows a camera (1) focused on the far range and an illumination source (3) which generates one or several blue-coloured beams (h).

A light beam (h) generated by the illumination source (3) is directed onto a pane (2) in such a manner that the beams reflected by the inner (2.1) and outer side (2.2) of the pane hit the objective or the camera (1) as two spatially separated beams (r1, r2′). The periphery of the beams can only be displayed out of focus on the imaging chip (5) due to the focus on the far range. But both beams (r1, r2′) are sufficiently separated and their respective illumination reflections can be detected by the image sensor (5).

In this embodiment of the invention, the main beam (h) of the illumination source (3) is used and the light of the illumination source can therefore be preferably bundled. The portion (r1) of the main beam reflected at the air-pane boundary (or the inner side of the pane (2.1)) serves as a reference beam. Of the portion (t1) transmitted into the pane, the portion that is reflected at the pane-raindrop boundary (or the outer side of the pane (2.2)) and hits the camera (1) serves as a measuring beam (r2′). The portion of the beam that is reflected multiple times inside the pane (2) (at the inner side (2.1) or pane-air boundary after having been reflected at the outer side (2.2) or pane-raindrop boundary) is not shown.

If, as shown here, the outer side (2.2) of the windscreen (2) is wetted in the case of rain (4), the major portion of the light (t1) is uncoupled and hence the reflected portion (r2′) weakened accordingly (see FIG. 2). The beam (r1) reflected by the inner side (2.1) remains unaffected by this.

On the condition that the constant ratio of the two illumination reflection signals to each other is known, the signal (r2′) reduced in the case of rain (4) can thus be measured by comparing the detected illumination reflections (8; 9) of both beams (r1 to r2′), and a windscreen wiper can be controlled accordingly.

By using FIGS. 5 to 7, it will be described later how rain can also be reliably determined just by evaluating the illumination reflection (9) from the outer side (2.2) of the pane (2).

The camera has a Bayer colour filter according to FIG. 1, and the measured signals are evaluated as explained using FIG. 2.

FIG. 4 shows seven pairs of illumination reflections (8, 9) in the upper part (6) of the image sensor (5) used for the detection of rain, said illumination reflections being generated by an illumination source (3) consisting e.g. of seven blue LEDs. Since the camera (1) is focused to infinity, these are not displayed in focus but are discernible. In particular, it is possible to measure the light intensity. The upper illumination reflections (8) are generated by beams (r1) reflected at the inner side (2.1) of the windscreen (2), the lower ones (9) are generated by beams (r2′) reflected at the outer side of the windscreen.

FIG. 4 thus shows an exemplary subdivision of the driver assistance region (7) and the rain sensor region (6) on the imaging chip (5). The illumination reflections from the outer windscreen (9) which are covered by a raindrop (4) are weakened in their intensity. These illumination reflections (9) are generated by beams (r2′) reflected at the outer side (2.2) of the windscreen (2) and are of reduced intensity, since a major portion of the beam (t1) transmitted into the windscreen (2) is uncoupled (t2′) from the windscreen by raindrops (4) and thus not reflected (r2′) back to the camera (1). Therefore these illumination reflections (9) carry the information of whether rain (4) is present on the outer side (2.2) of the pane (2), and their light quantity alone can be utilised as measurement signal.

As illustrated in FIGS. 5 to 7, even smallest raindrops can be detected after pixel-precise subtraction of the background (cf. the explanations using FIG. 2) and normalisation to the unaffected signal (for a dry pane).

FIG. 5 shows a spatial distribution of an illuminated area (9; measurement signals of the blue pixels) after pixel-precise subtraction of the background signal (determined in each case using the green and red pixels surrounding each blue pixel) for a dry pane. The reflectance intensity of blue light for individual blue pixels is designated here in arbitrary units in the range from 0 to 800 for two image coordinates in arbitrary units (from 0 to 30 in each case). FIG. 5 thus displays a realistic output signal for a dry pane.

A signal reduction due to wetting of the pane with raindrops depends on the size and thickness of the wetted area. FIG. 6 shows a spatial signal distribution (using the same designation as in FIG. 5) of the illuminated area (9) which is reduced in accordance with a wetting of the pane by a small raindrop (4) less than 1 mm in diameter.

By calculating the alteration of the volume from FIG. 6, which is overlapped by the “intensity landscape”, in comparison to the volume overlapped by the unaffected signal distribution from FIG. 5, it is possible not only to react sensitively to smallest raindrops but also to deduce the type of rain (raindrop size) or wetting and the amount of rain.

FIG. 7 shows the signal distribution of FIG. 6 normalised to the unaffected signal distribution of FIG. 5. The normalised reflectance intensity of blue light is designated here in the unit-free range from 0 to 1. The effect of the small raindrop (4) on the signal is very easy to see here as a symmetrical bulge (the normalised minimal value is approx. 0.6 to 0.7). Where the illumination beam (h) is not influenced by any raindrop (4), the normalised intensity value is approximately 1.

### REFERENCE SYMBOL LIST

1 camera
2 pane
2.1 inner side of the pane
2.2 outer side of the pane
3 illumination source
4 rain, raindrops
5 image sensor
6 rain sensor region
7 driver assistance region
8 illumination reflected by the inner side of the pane
9 illumination reflected by the outer side of the pane
10 signal change caused by raindrops
h beam
r1 portion of h reflected at the inner side of the pane
t1 portion of h transmitted at the inner side of the pane
r2′ portion of t1 reflected at the outer side of the pane (in case of rain)
t2′ portion of t1 transmitted at the outer side of the pane (in case of rain)
R filter element allowing light in the red wavelength range to pass
G filter element allowing light in the green wavelength range to pass
B filter element allowing light in the blue wavelength range to pass

1. A device for detecting rain (4) on a pane, the device comprising
a camera with an image sensor and colour filters for pixels of the image sensor (5) in a number of primary filter colours (R; G; B) and
an illumination source (3) configured and adapted to produce monochromatic light (h) of a first primary filter colour,
wherein the camera and the illumination source (3) are configured and arranged so that the camera can detect a signal from the monochromatic light (r1, r2′) with which the illumination source (3) illuminates the pane (2).

2. The device as claimed in claim 1, wherein the camera is arranged behind the pane (2) and focused on a far range located in front of the pane (2).

3. The device as claimed in claim 2, wherein the illumination source (3) directs the monochromatic light as at least one monochromatic light beam (h) onto the pane (2) so that at least one beam (r2′) reflected by an outer side (2.2) of the pane (2) hits the image sensor (5) of the camera.

4. The device as claimed in claim 3, wherein the at least one beam (r2′) reflected by the outer side (2.2) of the pane (2) hits the image sensor (5) of the camera without being superposed with beams (r1) reflected at an inner side (2.1) of the pane (2).

5. The device as claimed in claim 3, wherein the illumination source (3) directs the at least one monochromatic light beam (h) onto the pane (2) so that respective beams reflected by an inner (2.1) side and the outer side (2.2) of the pane hit the image sensor (5) of the camera as at least two spatially separated beams (r1 and r2′).

6. The device as claimed in claim 1, wherein the colour filters for the pixels of the image sensor (5) are transmission filters for three primary colours red (R), green (G) and blue (B).

7. The device as claimed in claim 6, wherein the colour filters are arranged in a Bayer pattern (RGGB).

8. The device as claimed in claim 1, wherein the illumination source (3) generates the monochromatic light (h) in a blue wavelength range.

9. The device as claimed in claim 1, wherein the primary filter colours (R; G; B) are provided in a visible wavelength range.

10. A method for detecting rain (4) with a camera (1), wherein
the camera comprises an image sensor and colour filters for pixels of the image sensor in a number of primary filter colours (R; G; B),
monochromatic light (h) of a first primary filter colour is generated by an illumination source (3),
a pane (2) is illuminated with the monochromatic light (h) so that the camera can detect a signal from the monochromatic light (r1, r2′).

11. The method as claimed in claim 10, wherein
a brightness value of a first image sensor pixel of the first primary filter colour is determined,
respective brightness values of surrounding pixels which surround the first image sensor pixel and have a primary filter colour differing from the first primary filter colour are determined, and
a background brightness of the first image sensor pixel is established by using the brightness values determined for the surrounding pixels which surround the first image sensor pixel and have a primary filter colour differing from the first primary filter colour.

12. The method as claimed in claim 11, wherein to establish the background brightness, an average value of the brightness values of the surrounding pixels which surround the first image sensor pixel and have a primary filter colour differing from the first primary filter colour is determined.

13. The method as claimed in claim 11, wherein to establish the background brightness, the brightness values of the surrounding pixels which have a second primary filter colour are weighted differently from the brightness values of the surrounding pixels which have a third primary filter colour, thereby taking a specific spectral distribution of a background into account.

14. The method as claimed in claim 11, wherein to eliminate the background brightness, only a colour component of a first primary filter colour in the brightness values of the surrounding pixels is subtracted from the brightness value determined for the first image sensor pixel having the first primary filter colour.

15. The method as claimed in claim 10, wherein a current background-eliminated measurement signal is normalised to a background-eliminated measurement signal for a dry pane (2).
